(19) United States
(12) Patent Application Publication
(10) Pub. No.: US 2017/0228679 A1
(43) Pub. Date: Aug. 10, 2017

(54) METHOD, APPARATUS, AND SYSTEM FOR SCORING BUSINESS MODEL, AND COMPUTER READABLE STORAGE MEDIUM

(71) Applicant: Shenzhen Development Promotion Centre for Enterprises, SHENZHEN GUANGDONG (CN)

(72) Inventors: Wei WEI, SHENZHEN GUANGDONG (CN); Wuxiang ZHU, SHENZHEN GUANGDONG (CN)

(73) Assignee: Shenzhen Development Promotion Centre for Enterprises, SHENZHEN GUANGDONG (CN)

(21) Appl. No.: 15/018,166

(22) Filed: Feb. 8, 2016

(51) Int. Cl. G06Q 10/06

(52) U.S. Cl. CPC G06Q 10/06393

(57) ABSTRACT

A method, an apparatus, and a system for scoring a business model, and a computer readable storage medium are disclosed. Corresponding individual item scoring data is generated according to an individual item scoring parameter entered by a user for a business model to be scored; and further, the generated individual item scoring data is summated, and business model scoring data is obtained. By using the scoring data, a unified comparison and quantitative analysis may be performed on a business model of an enterprise, so that when the enterprise selects a business model, the enterprise may effectively evaluate optional business models, which promotes realization of value of the business model in the enterprise.

### TECHNICAL FIELD

The present invention relates to the data analysis processing field, and in particular, to a method, an apparatus, and a system for scoring a business model, and a computer readable storage medium.

### BACKGROUND

With continuous advancement of science and technology and continuous development of innovations, how to successfully apply a new invention or creative idea to business operation and enterprise development to achieve operational performance is a common concern in various industries of the society. The concept of business model is put forward just to set up a bridge between creative idea and enterprise operation.

Since 1950s, more than 200 business models have been defined in the academic field. Lack of a unified definition, in particular, lack of an effective analysis tool, greatly constrains realization of value of the concept of business model.

A good creative idea, a good product, and an innovative technology all require a suitable business model to match them, so that their real value can be realized. The value created by the same technology, product, or concept by using different business models differs greatly. Therefore, in a development process of an enterprise, the enterprise needs to select a business model cautiously to fully explore the value of the enterprise.

In evaluating the business model of the enterprise, an existing theory for analyzing the business model mainly lays an emphasis on qualitative analysis, and cannot perform a unified comparison and quantitative analysis on the business model of the enterprise. Therefore, when the enterprise selects a business model, it is very difficult for the enterprise to effectively evaluate optional business models, hick constrains realization of the value of the business model in the enterprise.

### SUMMARY

Objectives of the present invention are to provide a method, an apparatus, and a system for scoring a business model of an enterprise, and a computer readable storage medium.

A method for scoring a business model is disclosed, where the method includes the following steps:

receiving an individual item scoring parameter entered by a user for a business model to be scored;

generating corresponding individual item scoring data according to the individual item scoring parameter;

summating the generated individual item scoring data, and generating business model scoring data; where

the individual item scoring parameter includes at least one of a market capacity parameter, a value creativity parameter, a value proposition superiority parameter, a key resource capacity sufficiency parameter, a stakeholder motivation parameter, a business model barrier parameter, an environment adaptability parameter, a personnel efficiency parameter, an investment efficiency parameter, and a growth efficiency parameter.

An apparatus for scoring a business model is disclosed, where the apparatus includes:

an individual item scoring parameter receiving unit, configured to receive an individual item scoring parameter entered by a user for a business model to be scored;

an individual item scoring data generation unit, configured to generate corresponding individual item scoring data according to the individual item scoring parameter; and

a business model scoring data generation unit, configured to summate the generated individual item scoring data, and generate business model scoring data; where

the individual item scoring parameter includes at least one of a market capacity parameter, a value creativity parameter, a value proposition superiority parameter, a key resource capacity sufficiency parameter, a stakeholder motivation parameter, a business model barrier parameter, an environment adaptability parameter, a personnel efficiency parameter, an investment efficiency parameter, and a growth efficiency parameter.

A system for scoring a business model is disclosed, where the system includes:

a bus, configured to transmit signaling and data;

a user interface adapter, configured to connect an input device to the bus, and receive an individual item scoring parameter entered by a user for a business model to be scored;

a display adapter, configured to connect a display device to the bus; and display an individual item scoring parameter input interface and business model scoring data;

a business model scoring apparatus, configured to receive the individual item scoring parameter entered by the user for the business model to be scored, generate corresponding individual item scoring data according to the individual item scoring parameter, summate the generated individual item scoring data, and generate business model scoring data; where

the individual item scoring parameter includes at least one of a market capacity parameter, a value creativity parameter, a value proposition superiority parameter, a key resource capacity sufficiency parameter, a stakeholder motivation parameter, a business model barrier parameter, an environment adaptability parameter, a personnel efficiency parameter, an investment efficiency parameter, and a growth efficiency parameter.

A computer readable storage medium is disclosed, where the computer readable storage medium stores a computer program instruction executable by a computer, and when the computer executes the computer program instruction, the computer executes a method for scoring a business model, where the method for scoring a business model includes:

receiving an individual item scoring parameter entered by a user for a business model to be scored;

generating corresponding individual item scoring data according to the individual item scoring parameter;

summating the generated individual item scoring data, and generating business model scoring data; where

the individual item scoring parameter includes at least one of a market capacity parameter, a value creativity parameter, a value proposition superiority parameter, a key resource capacity sufficiency parameter, a stakeholder motivation parameter, a business model barrier parameter, an environment adaptability parameter, a personnel efficiency parameter, an investment efficiency parameter; and a growth efficiency parameter.

In specific implementation manners of a method and an apparatus for scoring a business model according to the present invention, corresponding individual item scoring data is generated according to an individual item scoring parameter entered by a user for a business model to be scored; and further, the generated individual item scoring data is summated, and business model scoring data is obtained. By using the scoring data, a unified comparison and quantitative analysis may be performed on a business model of an enterprise, so that when the enterprise selects a business model, the enterprise may effectively evaluate optional business models, which promotes realization of value of the business model in the enterprise.

### BRIEF DESCRIPTION OF DRAWINGS

FIG. 1 is a flowchart of a specific implementation manner of a method for scoring a business model according to the present invention;

FIG. 2 is a flowchart of a specific implementation manner of generating corresponding individual item scoring data according to an individual item scoring parameter according to the present invention;

FIG. 3 is a schematic block diagram of a specific implementation manner of an apparatus for scoring a business model according to the present invention;

FIG. 4 is a schematic block diagram of a specific implementation manner of an individual item scoring data generation unit according to the present invention; and

FIG. 5 is a schematic block diagram of a specific implementation manner of a system for scoring a business model according to the present invention.

### DESCRIPTION OF EMBODIMENTS

In the present invention, corresponding individual item scoring data is generated according to an individual item scoring parameter entered by a user for a business model to be scored; and further, the generated individual item scoring data is summated, and business model scoring data is obtained. By using the scoring data, a unified comparison and quantitative analysis may be performed on a business model of an enterprise, so that when the enterprise selects a business model, the enterprise may effectively evaluate optional business models, which promotes realization of value of the business model in the enterprise.

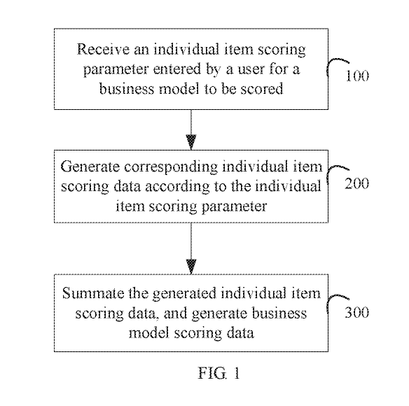

FIG. 1 shows a specific implementation manner of a method for scoring a business model according to the present invention. The method includes:

Step 100: Receive an individual item scoring parameter entered by a user for a business model to be scored, where the individual item scoring parameter includes at least one of a market capacity parameter, a value creativity parameter, a value proposition superiority parameter, a key resource capacity sufficiency parameter, a stakeholder motivation parameter, a business model barrier para an environment adaptability parameter, a personnel efficiency parameter, an investment efficiency parameter, and a growth efficiency parameter.

In the present invention, without considering the price of a product or a strategy of a supplier, a market capacity refers to a quantity of unit products or labor services that can be consumed in a market in a period of time. The market capacity parameter may be a specific numeric value, for example, a turnover of USD 150,000,000, a net profit of RMB 10,000,000, or the like, or may be a grade evaluation parameter, for example, high, middle, or low.

In the present invention, value creativity indicates whether great new value can be created in a current business model in contrast to an existing business model of an industry. The value creativity parameter may be a specific numeric value, or may be an evaluation result, for example, yes or no.

In the present invention, value proposition superiority indicates whether a product or service provided for a customer and a provision mode thereof can bring about better customer satisfaction. The value proposition superiority parameter may be a specific numeric value, or may be an evaluation result, for example, yes or no.

In the present invention, key resource capacity sufficiency indicates whether an enterprise has important resources and capacities required by the business model. The key resource capacity sufficiency parameter may be a specific numeric value, or may be an evaluation result, for example, yes or no.

In the present invention, a stakeholder motivation indicates whether the business model can better stimulate a stakeholder so that the stakeholder actively participates in a transaction. The stakeholder motivation parameter may be a specific numeric value, or may be an evaluation result, for example, yes or no.

In the present invention, a business model barrier indicates whether the enterprise is capable of avoiding being quickly followed by a competitor (including a potential competitor), or whether the enterprise is capable of continuously upgrading the business model if the enterprise is followed by a competitor (including a potential competitor). The business model barrier parameter may be a specific numeric value, or may be an evaluation result, for example, yes or no.

In the present invention, environment adaptability indicates whether a great change may occur in an external environment of the enterprise, or whether the enterprise may be affected if a great change occurs in an external environment of the enterprise, or whether the enterprise is capable of quickly responding by adjusting the business model if the enterprise is affected by a change of an external environment of the enterprise. The environment adaptability parameter may be a specific numeric value, or may be an evaluation result, for example, yes or no.

In the present invention, personnel efficiency of the enterprise in the business model refers to an average net profit or turnover that can be created by each employee. The personnel efficiency parameter may be a specific numeric value, or may be a grade evaluation result, for example, high, middle, or low.

In the present invention, investment efficiency refers to a return on total assets or a return on net assets of the enterprise in the business model. The investment efficiency parameter may be a specific numeric value, or may be a grade evaluation result, for example, high, middle, or low.

In the present invention, growth efficiency refers to an average annual growth rate of turnovers or net profits in last three to five years. The growth efficiency parameter may be a specific numeric value, or may be a grade evaluation result, for example, high, middle, or low.

Step 200: Generate corresponding individual item scoring data according to the individual item scoring parameter.

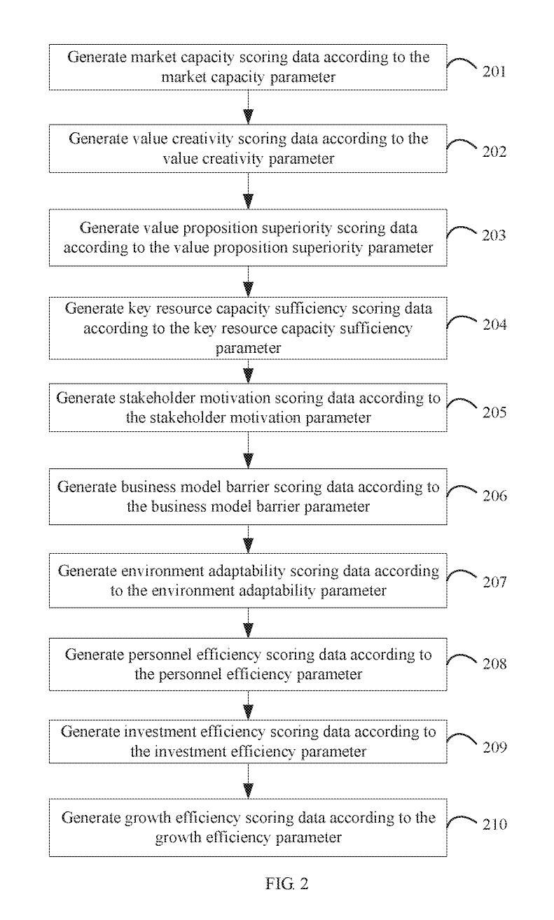

In the present invention, the individual item scoring data includes market capacity scoring data, value creativity scoring data, value proposition superiority scoring data, key resource capacity sufficiency scoring data, stakeholder motivation scoring data, business model barrier scoring data, environment adaptability scoring data, personnel efficiency scoring data, investment efficiency scoring data, and growth efficiency scoring data. Referring to FIG. 2, the step of generating corresponding individual item scoring data according to the individual item scoring parameter is specifically:

Step 201: Generate market capacity scoring data according to the market capacity parameter.

Step 202: Generate value creativity scoring data according to the value creativity parameter.

Step 203: Generate value proposition superiority scoring data according to the value proposition superiority parameter.

Step 204: Generate key resource capacity sufficiency scoring data according to the key resource capacity sufficiency parameter.

Step 205: Generate stakeholder motivation scoring data according to the stakeholder motivation parameter.

Step 206: Generate business model barrier scoring data according to the business model barrier parameter.

Step 207: Generate environment adaptability scoring data according to the environment adaptability parameter.

Step 208: Generate personnel efficiency scoring data according to the personnel efficiency parameter.

Step 209: Generate investment efficiency scoring data according to the investment efficiency parameter.

Step 210: Generate growth efficiency scoring data according to the growth efficiency parameter.

The foregoing steps may be performed simultaneously, or may be performed according to a sequence, which is not specifically limited.

The method for generating individual item scoring data is hereinafter described by using an example in which the individual item scoring data is market capacity scoring data.

In an embodiment of the present invention, when the market capacity parameter is a specific numeric value, generating market capacity scoring data according to the market capacity parameter is specifically:

comparing the market capacity parameter with a preset market capacity scoring indicator parameter, and obtaining comparison result data; and

obtaining the corresponding market capacity scoring data from a prestored market capacity scoring table according to the comparison result data.

In the present invention, the comparison result data may be a ratio of the market capacity parameter to the preset market capacity scoring indicator parameter, a difference between the two parameters, or the like.

When the comparison result data is the ratio of the market capacity parameter to the preset market capacity scoring indicator parameter, the prestored market capacity scoring table may use the following form:

TABLE 1

| Comparison result data | Market capacity scoring data |
|---|---|
| (0, 0.5] | 2 |
| (0.5, 1] | 5 |
| (1, 1.5] | 8 |
| (1.5, +∝) | 10 |

As shown in the foregoing table, when the ratio of the market capacity parameter to the market capacity scoring indicator parameter is less than or equal to 0.5, the market capacity scoring data is equal to 2; when the ratio of the market capacity parameter to the market capacity scoring indicator parameter is greater than 0.5 but less than or equal to 1, the market capacity scoring data is equal to 5; when the ratio of the market capacity parameter to the market capacity scoring indicator parameter is greater than 1 but less than or equal to 1.5, the market capacity scoring data is equal to 8; when the ratio of the market capacity parameter to the market capacity scoring indicator parameter is greater than 1.5, the market capacity scoring data is equal to 10.

In an embodiment of the present invention, when the market capacity parameter is a grade evaluation parameter, generating market capacity scoring data according to the market capacity parameter is specifically:

obtaining, from a prestored market capacity scoring table according to the market capacity parameter, the market capacity scoring data corresponding to the market capacity parameter.

When the market capacity parameter is a grade evaluation parameter, the prestored market capacity scoring table may use the following form.

TABLE 2

| Market capacity parameter | Market capacity scoring data |
|---|---|
| High | 10 |
| Middle | 5 |
| Low | 1 |

It is understandable that the foregoing methods for obtaining market capacity scoring data are only some specific instances, and are not used to limit the present invention. All of the foregoing market capacity scoring data, value creativity scoring data, value proposition superiority scoring data, key resource capacity sufficiency scoring data, stakeholder motivation scoring data, business model barrier scoring data, environment adaptability scoring data, personnel efficiency scoring data, investment efficiency scoring data, and growth efficiency scoring data may be obtained in a manner similar to the manner of obtaining market capacity scoring data, which is not further described herein.

In the present invention, maximum values of the foregoing market capacity scoring data, value creativity scoring data, value proposition superiority scoring data, key resource capacity sufficiency scoring data, stakeholder motivation scoring data, business model barrier scoring data, environment adaptability scoring data, personnel efficiency scoring data, investment efficiency scoring data, and growth efficiency scoring data are 10, and minimum values thereof are 0. This is more advantageous for making a horizontal comparison between multiple different business models.

Step 300: Summate the generated individual item scoring data, and generate business model scoring data.

In a method for scoring a business model according to an embodiment of the present invention, individual item scoring data is generated according to an individual item scoring parameter entered by a user for a business model to be scored; and further, the individual item scoring data is summated, and finally business model scoring data is generated. Because the method provides a unified comparison and quantitative analysis method for scoring a business model, when an enterprise selects a business model, the enterprise can effectively evaluate optional business models horizontally, which promotes realization of value of the business model in the enterprise.

FIG. 3 shows a specific implementation manner of an apparatus for scoring a business model according to the present invention. The apparatus 50 includes an individual item scoring parameter receiving unit 51, an individual item scoring data generation unit 52, and a business model scoring data generation unit 53.

The individual item scoring parameter receiving unit 51 is configured to receive an individual item scoring parameter entered by a user for a business model to be scored, where the individual item scoring parameter includes at least one of a market capacity parameter, a value creativity parameter, a value proposition superiority parameter, a key resource capacity sufficiency parameter, a stakeholder motivation parameter, a business model barrier parameter, an environment adaptability parameter, a personnel efficiency parameter, an investment efficiency parameter, and a growth efficiency parameter.

In the present invention, without considering the price of a product or a strategy of a 2.0 supplier, a market capacity refers to a quantity of unit products or labor services that can be consumed in a market in a period of time. The market capacity parameter may be a specific numeric value, for example, a turnover of USD 150,000,000, a net profit of RMB 10,000,000, or the like, or may be a grade evaluation parameter, for example, high, middle, or low.

In the present invention, value creativity indicates whether great new value can be created in a current business model in contrast to an existing business model of an industry. The value creativity parameter may be a specific numeric value, or may be an evaluation result, for example, yes or no.

In the present invention, value proposition superiority indicates whether a product or service provided for a customer and a provision mode thereof can bring about better customer satisfaction. The value proposition superiority parameter may be a specific mimetic value, or may be an evaluation result, for example, yes or no.

In the present invention, key resource capacity sufficiency indicates whether an enterprise has important resources and capacities required by the business model. The key resource capacity sufficiency parameter may be a specific numeric value, or may be an evaluation result, for example, yes or no.

In the present invention, a stakeholder motivation indicates whether the business model can better stimulate a stakeholder so that the stakeholder actively participates in a transaction. The stakeholder motivation parameter may be a specific numeric value, or may be an evaluation result, for example, yes or no.

In the present invention, a business model barrier indicates whether the enterprise is capable of avoiding being quickly followed by a competitor (including a potential competitor), or whether the enterprise is capable of continuously upgrading the business model if the enterprise is followed by a competitor (including a potential competitor). The business model barrier parameter may be a specific numeric value, or may be an evaluation result, for example, yes or no.

In the present invention, environment adaptability indicates whether a great change may occur in an external environment of the enterprise, or whether the enterprise may be affected if a great change occurs in an external environment of the enterprise, or whether the enterprise is capable of quickly responding by adjusting the business model if the enterprise is affected by a change of an external environment of the enterprise. The environment adaptability parameter may be a specific numeric value, or may be an evaluation result, for example, yes or no.

In the present invention, personnel efficiency of the enterprise in the business model refers to an average net profit or turnover that can be created by each employee. The personnel efficiency parameter may be a specific numeric value, or may be a grade evaluation result, for example, high, middle, or low.

In the present invention, investment efficiency refers to a return on total assets or a return on net assets of the enterprise in the business model. The investment efficiency parameter may be a specific numeric value, or may be a grade evaluation result, for example, high, middle, or low.

In the present invention, growth efficiency refers to an average annual growth rate of turnovers or net profits in last three to five years. The growth efficiency parameter may be a specific numeric value, or may be a grade evaluation result, for example, high, middle, or low.

The individual item scoring data generation unit 52 is configured to generate corresponding individual item scoring data according to the individual item scoring parameter.

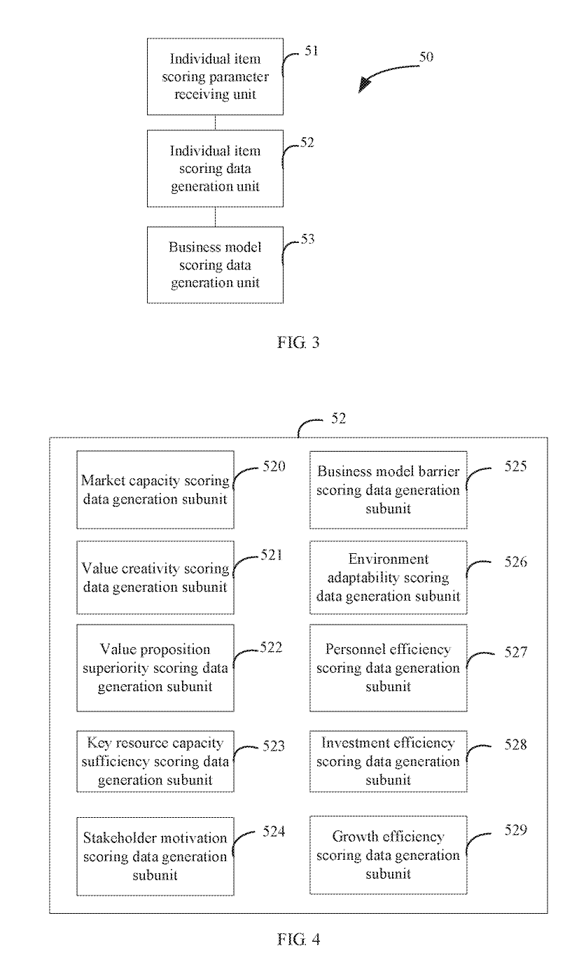

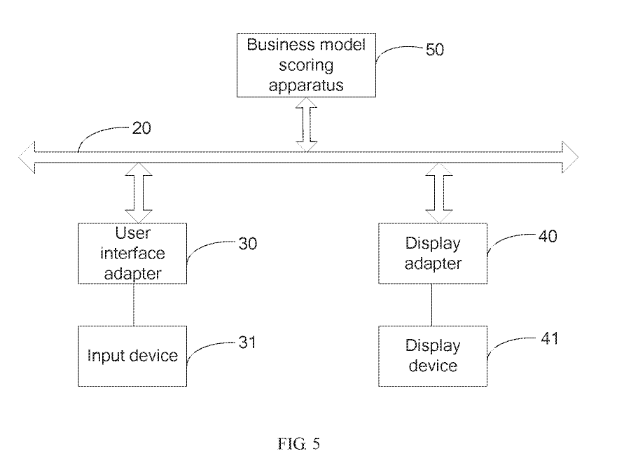

In the present invention, the individual item scoring data includes market capacity scoring data, value creativity scoring data, value proposition superiority scoring data, key resource capacity sufficiency scoring data, stakeholder motivation scoring data, business model barrier scoring data, environment adaptability scoring data, personnel efficiency scoring data, investment efficiency scoring data, and growth efficiency scoring data. As shown in FIG. 4, the individual item scoring data generation unit 52 includes:

a market capacity scoring data generation subunit 520, configured to generate market capacity scoring data according to the market capacity parameter;

a value creativity scoring data generation subunit 521, configured to generate value creativity scoring data according to the value creativity parameter;

a value proposition superiority scoring data generation subunit 522, configured to generate value proposition superiority scoring data according to the value proposition superiority parameter;

a key resource capacity sufficiency scoring data generation subunit 523, configured to generate key resource capacity sufficiency scoring data according to the key resource capacity sufficiency parameter;

a stakeholder motivation scoring data generation subunit 524, configured to generate stakeholder motivation scoring data according to the stakeholder motivation parameter;

a business model barrier scoring data generation subunit 525, configured to generate business model barrier scoring data according to the business model barrier parameter;

an environment adaptability scoring data generation subunit 526, configured to generate environment adaptability scoring data according to the environment adaptability parameter;

a personnel efficiency scoring data generation subunit 527, configured to generate personnel efficiency scoring data according to the personnel efficiency parameter;

an investment efficiency scoring data generation subunit 528, configured to generate investment efficiency scoring data according to the investment efficiency parameter; and

a growth efficiency scoring data generation subunit 529, configured to generate growth efficiency scoring data according to the growth efficiency parameter.

In the present invention, maximum values of the foregoing market capacity scoring data, value creativity scoring data, value proposition superiority scoring data, key resource capacity sufficiency scoring data, stakeholder motivation scoring data, business model barrier scoring data, environment adaptability scoring data, personnel efficiency scoring data, investment efficiency scoring data, and growth efficiency scoring data are 10, and minimum values thereof are 0. This is more advantageous for making a horizontal comparison between multiple different business models.

The business model scoring data generation unit 53 is configured to summate the generated individual item scoring data, and generate business model scoring data.

In an apparatus for scoring a business model according to an embodiment of the present invention, individual item scoring data is generated according to an individual item scoring parameter entered by a user for a business model to be scored; and further, the individual item scoring data is summated, and finally business model scoring data is generated. Because the method provides a unified comparison and quantitative analysis method for scoring a business model, when an enterprise selects a business model, the enterprise can effectively evaluate optional business models horizontally, which promotes realization of value of the business model in the enterprise.

FIG. 4 shows a specific implementation manner of a system for scoring a business model. The system includes:

a bus 20, configured to transmit signaling and data;

a user interface adapter 30, configured to connect an input device 31 to the bus 20, and receive an individual item scoring parameter entered by a user for a business model to be scored, where the input device includes but is not limited to a keyboard, a mouse, a speaker, a microphone, or the like;

a display adapter 40, configured to connect a display device 41 to the bus 20, and display an individual item scoring parameter input interface and business model scoring data, where the display device may be a display, a printer, or an information generation apparatus; and

a business model scoring apparatus 50, as described in the specific implementation manner corresponding to FIG. 2, configured to receive the individual item scoring parameter that is entered by the user for the business model to be scored and is transmitted by the user interface adapter 30 through the bus, generate corresponding individual item scoring data according to the individual item scoring parameter, summate the generated individual item scoring data, generate business model scoring data, and transmit the business model scoring data to the display adapter 40 through the bus 20.

The business model scoring apparatus 50 may be implemented by hardware, or implemented by software, or implemented by a combination of software and hardware.

The apparatus is not described exhaustively herein. For detailed information, reference may be made to the detailed description in the specific implementation manner of the apparatus for scoring a business model.

In a system for scoring a business model according to an embodiment of the present invention, individual item scoring data is generated according to an individual item scoring parameter entered by a user for a business model to be scored; and further, the individual item scoring data is summated, and finally business model scoring data is generated. Because the method provides a unified comparison and quantitative analysis method for scoring a business model, when an enterprise selects a business model, the enterprise can effectively evaluate optional business models horizontally, which promotes realization of value of the business model in the enterprise.

A person of ordinary skill in the art understands that each aspect of the present invention or a possible implementation manner of each aspect may be specifically implemented as a system, a method, or a computer program product. Therefore, each aspect of the present invention or the possible implementation manner of each aspect may use a form of hardware only embodiments, software only embodiments (including firmware, resident software, and the like), or embodiments with a combination of software and hardware, which are collectively called “a circuit”. “a module”, or “a system”. In addition, each aspect of the present invention or the possible implementation manner of each aspect may use a form of a computer program product, where the computer program product refers to computer readable program code stored in a computer readable medium.

The computer readable medium may be a computer readable signal medium or a computer readable storage medium. A computer readable storage medium includes but is not limited to an electronic, magnetic, optical, electromagnetic, infrared, or semiconductor system, device, or apparatus, or any suitable combination of the foregoing, for example, a random access memory (RAM), a read-only memory (ROM), an erasable programmable read-only memory (EPROM or flash memory), an optical fiber, or a portable compact disc read-only memory (CD-ROM).

A processor in a computer reads the computer readable program code stored in the computer readable medium, so that the processor can execute each step in the flowchart or function actions specified in a combination of steps, and generate an apparatus for implementing each block in a block diagram or function actions specified in a combination of blocks.

The computer readable program code may be completely executed on a computer of a user, or partially executed on a computer of a user, or as an independent software package, partially executed on a computer of a user and partially executed on a remote computer, or completely executed on a remote computer or a server. It should also be noted that in some alternative implementation solutions, each step in the flowchart or the function indicated by each block in the block diagram may occur not in accordance with the sequence indicated in the drawing. For example, two steps or two blocks that are connected and shown depending on involved functions may be actually executed approximately at the same time, or sometimes these blocks may be executed in a reverse sequence.

It is apparent to a person skilled in the art that various modifications and variations can be made to the present invention without departing from the scope or spirit of the present invention. The present invention is intended to cover these modifications and variations provided that they fall within the scope of protection defined by the following claims and their equivalent technologies.

1. A method for scoring a business model, wherein the method comprises the following steps:
receiving an individual item scoring parameter entered by a user for a business model to be scored;
generating corresponding individual item scoring data according to the individual item scoring parameter;
summating the generated individual item scoring data, and generating business model scoring data; wherein
the individual item scoring parameter comprises at least one of a market capacity parameter, a value creativity parameter, a value proposition superiority parameter, a key resource capacity sufficiency parameter, a stakeholder motivation parameter, a business model barrier parameter, an environment adaptability parameter, a personnel efficiency parameter, an investment efficiency parameter, and a growth efficiency parameter.

2. The method for scoring a business model according to claim 1, wherein when the individual item scoring parameter is a specific numeric value, the step of generating corresponding individual item scoring data according to the individual item scoring parameter is specifically:
comparing the individual item scoring parameter with a preset individual item scoring indicator parameter, and obtaining comparison result data; and
obtaining, from a prestored corresponding individual item scoring table according to the comparison result data, the individual item scoring data corresponding to the individual item scoring parameter.

3. The method for scoring a business model according to claim 1, wherein when the individual item scoring parameter is a grade evaluation parameter, the step of generating corresponding individual item scoring data according to the individual item scoring parameter is specifically:
obtaining, from a prestored corresponding individual item scoring table according to the individual item scoring parameter, the individual item scoring data corresponding to the individual item scoring parameter.

4. The method according to claim 1, wherein the individual item scoring data is greater than or equal to 0 but less than or equal to 10.

5. The method according to claim 1, wherein the step of generating corresponding individual item scoring data according to the individual item scoring parameter is specifically:
generating market capacity scoring data according to the market capacity parameter;
generating value creativity scoring data according to the value creativity parameter;
generating value proposition superiority scoring data according to the value proposition superiority parameter;
generating key resource capacity sufficiency scoring data according to the key resource capacity sufficiency parameter;
generating stakeholder motivation scoring data according to the stakeholder motivation parameter;
generating business model barrier scoring data according to the business model barrier parameter;
generating environment adaptability scoring data according to the environment adaptability parameter;
generating personnel efficiency scoring data according to the personnel efficiency parameter;
generating investment efficiency scoring data according to the investment efficiency parameter; and
generating growth efficiency scoring data according to the growth efficiency parameter.

6. An apparatus for scoring a business model, wherein the apparatus comprises:
an individual item scoring parameter receiving unit, configured to receive an individual item scoring parameter entered by a user for a business model to be scored;
an individual item scoring data generation unit, configured to generate corresponding individual item scoring data according to the individual item scoring parameter; and
a business model scoring data generation unit, configured to summate the generated individual item scoring data, and generate business model scoring data; wherein
the individual item scoring parameter comprises at least one of a market capacity parameter, a value creativity parameter, a value proposition superiority parameter, a key resource capacity sufficiency parameter, a stakeholder motivation parameter, a business model barrier parameter, an environment adaptability parameter, a personnel efficiency parameter, an investment efficiency parameter, and a growth efficiency parameter.

7. The apparatus according to claim 6, wherein when the individual item scoring parameter is a specific numeric value, the individual item scoring data generation unit comprises:
a comparison result obtaining subunit, configured to compare the individual item scoring parameter with a preset individual item scoring indicator parameter, and obtain comparison result data; and
a first individual item scoring data obtaining subunit, configured to obtain, from a prestored corresponding individual item scoring table according to the comparison result data, the individual item scoring data corresponding to the individual item scoring parameter.

8. The apparatus according to claim 6, wherein when the individual item scoring parameter is a grade evaluation parameter, the individual item scoring data generation unit comprises:
a second individual item scoring data obtaining subunit, configured to obtain, from a prestored corresponding individual item scoring table according to the individual item scoring parameter, the individual scoring data corresponding to the individual item scoring parameter.

9. The apparatus according to claim 6, wherein the individual item scoring data is greater than or equal to 0 but less than or equal to 10.

10. The apparatus according to claim 6, wherein the individual item scoring data generation unit comprises:
a market capacity scoring data generation subunit, configured to generate market capacity scoring data according to the market capacity parameter;
a value creativity scoring data generation subunit, configured to generate value creativity scoring data according to the value creativity parameter;
a value proposition superiority scoring data generation subunit, configured to generate value proposition superiority scoring data according to the value proposition superiority parameter;
a key resource capacity sufficiency scoring data generation subunit, configured to generate key resource capacity sufficiency scoring data according to the key resource capacity sufficiency parameter;
a stakeholder motivation scoring data generation subunit, configured to generate stakeholder motivation scoring data according to the stakeholder motivation parameter;
a business model barrier scoring data generation subunit, configured to generate business model barrier scoring data according to the business model barrier parameter;
an environment adaptability scoring data generation subunit, configured to generate environment adaptability scoring data according to the environment adaptability parameter;
a personnel efficiency scoring data generation subunit, configured to generate personnel efficiency scoring data according to the personnel efficiency parameter;
an investment efficiency scoring data generation subunit, configured to generate investment efficiency scoring data according to the investment efficiency parameter; and
a growth efficiency scoring data generation subunit, configured to generate growth efficiency scoring data according to the growth efficiency parameter.

11. A system for scoring a business model, wherein the system comprises:
a bus, configured to transmit signaling and data;
a user interface adapter, configured to connect an input device to the bus, and receive an individual item scoring parameter entered by a user for a business model to be scored;
a display adapter, configured to connect a display device to the bus, and display an individual item scoring parameter input interface and business model scoring data;
a business model scoring apparatus, configured to receive the individual item scoring parameter entered by the user for the business model to be scored, generate corresponding individual item scoring data according to the individual item scoring parameter, summate the generated individual item scoring data, and generate business model scoring data; wherein
the individual item scoring parameter comprises at least one of a market capacity parameter, a value creativity parameter, a value proposition superiority parameter, a key resource capacity sufficiency parameter, a stakeholder motivation parameter, a business model barrier parameter, an environment adaptability parameter, a personnel efficiency parameter, an investment efficiency parameter, and a growth efficiency parameter.

12. The system for scoring a business model according to claim 11, wherein the individual item scoring data is greater than or equal to 0 but less than or equal to 10.

13. A computer readable storage medium, wherein the computer readable storage medium stores a computer program instruction executable by a computer, and when the computer executes the computer program instruction, the computer executes a method for scoring a business model, wherein the method for scoring a business model comprises:
receiving an individual item scoring parameter entered by a user for a business model to be scored;
generating corresponding individual item scoring data according to the individual item scoring parameter;
summating the generated individual item scoring data, and generating business model scoring data; wherein
the individual item scoring parameter comprises at least one of a market capacity parameter, a value creativity parameter, a value proposition superiority parameter, a key resource capacity sufficiency parameter, a stakeholder motivation parameter, a business model barrier parameter, an environment adaptability parameter, a personnel efficiency parameter, an investment efficiency parameter, and a growth efficiency parameter.

14. The computer readable storage medium according to claim 13, wherein when the individual item scoring parameter is a specific numeric value, the step of generating corresponding individual item scoring data according to the individual item scoring parameter is specifically:
comparing the individual item scoring parameter with a preset individual item scoring indicator parameter, and obtaining comparison result data; and
obtaining, from a prestored corresponding individual item scoring table according to the comparison result data, the individual item scoring data corresponding to the individual item scoring parameter.

15. The computer readable storage medium according to claim 13, wherein when the individual item scoring parameter is a grade evaluation parameter, the step of generating corresponding individual item scoring data according to the individual item scoring parameter is specifically:
obtaining, from a prestored corresponding individual item scoring table according to the individual item scoring parameter, the individual item scoring data corresponding to the individual item scoring parameter.

16. The computer readable storage medium according to claim 13, wherein the individual item scoring data is greater than or equal to 0 but less than or equal to 10.

17. The computer readable storage medium according to claim 13, wherein the step of generating corresponding individual item scoring data according to the individual item scoring parameter is specifically:
generating market capacity scoring data according to the market capacity parameter;
generating value creativity scoring data according to the value creativity parameter;
generating value proposition superiority scoring data according to the value proposition superiority parameter;
generating key resource capacity sufficiency scoring data according to the key resource capacity sufficiency parameter;
generating stakeholder motivation scoring data according to the stakeholder motivation parameter;
generating business model barrier scoring data according to the business model barrier parameter;
generating environment adaptability scoring data according to the environment adaptability parameter;
generating personnel efficiency scoring data according to the personnel efficiency parameter;
generating investment efficiency scoring data according to the investment efficiency parameter; and
generating growth efficiency scoring data according to the growth efficiency parameter.
